(19) United States
(12) Patent Application Publication
(10) Pub. No.: US 2010/0183805 A1
(43) Pub. Date: Jul. 22, 2010

(54) METHOD OF MANUFACTURING AN OPTICAL PRODUCT, AND AN APPARATUS

(75) Inventor: Olavi Nieminen, Vanhalinna (FI)

Correspondence Address: OLIFF & BERRIDGE, PLC, P.O. BOX 320850, ALEXANDRIA, VA, 22320-4850, US

(73) Assignee: THETA OPTICS LTD OY, Lieto (FI)

(21) Appl. No.: 12/667,122

(22) PCT Filed: Jul. 3, 2008
(86) PCT No.: PCT/FI2008/050407

§ 371 Date: Dec. 29, 2009

(30) Foreign Application Priority Data
Jul. 4, 2007 (FI) 20075507

(51) Int. Cl. B05D 5/06; B05C 13/02

(52) U.S. Cl. 427/162; 118/504

(57) ABSTRACT

A method and apparatus for manufacturing an optical workpiece. In the method at least one side of the workpiece is coated. The workpiece is handled through a jig attached non-detachably to an optical area of the workpiece.

### BACKGROUND OF THE INVENTION

The invention relates to a method of manufacturing an optical workpiece, in which method at least one side of the workpiece is coated.

Further, the invention relates to an apparatus for manufacturing an optical workpiece out of a workpiece.

Several methods are known for manufacturing coated optical products, such as eyeglasses, sunglasses and protective eyepieces, the dimensions and 3d shape differences of which are great. There are some problems relating to the manufacturing thereof.

For example, in manufacturing eyeglasses a large number of different lenses or lens preforms causes problems in the coating processes in their treatment. The diameter of the lenses or lens preforms varies between 45 mm and 80 mm at spacings of 0.5 mm—considering thickness and curvature variations, there are hundreds of alternatives. Due to the large number of lenses or lens preforms, it is impossible to create automatic treatment systems for lenses or lens preforms. In the prior art, treatment of a lens or lens preform includes numerous handiwork-like stages in which the lens or lens preform is arranged on a fastener, bracket or fitting ring manufactured specifically according to the dimensions of the preform in question. Subsequently, the lenses or lens preforms are arranged in treatment devices by means of the fastener or bracket. This kind of manufacture is slow and expensive. Further, it is typical that the lens preforms are transported and used in various different work processes before the desired final result is achieved.

### BRIEF DESCRIPTION OF THE INVENTION

An object of the invention is to provide a novel and improved method and apparatus.

The method according to the invention is characterized by treating the surface of the workpiece with a process improving adhesion, after which a first coating and an outer coating are applied onto the surface in such a way that all method steps from the adhesion-improving process to applying the outer coating are performed in an automatic production process in which a conveyor system transports the workpieces to the adhesion-improving process and finally out of the application step of the outer coating.

The apparatus according to the invention is characterized in that it comprises means for treating the surface of the workpiece with a process improving adhesion, means for applying a first coating onto the treated surface, means for applying an outer coating, and a conveyor system arranged to transport the workpieces to the adhesion-improving process and finally out of the application step of the outer coating.

The idea of an embodiment of the invention is that the workpieces, i.e. lenses or lens preforms, comprise a standard-sized jig, owing to which the lens or lens preform can be treated with automatic treatment means, such as robots and manipulators or the like.

### BRIEF DESCRIPTION OF THE FIGURES

Embodiments of the invention will be described in greater detail in the attached drawings, in which

FIG. 1 shows schematically a phase diagram of a method according to the invention;

FIG. 2 shows schematically a side view and a top view of lens preforms used in the method according to the invention;

FIGS. 3a and 3b show schematically a side view of some steps of the method according to the invention;

FIG. 4 shows schematically a side view of an optical product manufactured with the method according to the invention, indicating the different structural layers separately;

FIG. 5 shows schematically a side view of a second optical product manufactured with the method according to the invention, indicating the different structural layers separately;

FIG. 6 shows a dip method;

FIGS. 7a and 7b show schematically a top view of a lens preform used in the method according to the invention;

FIG. 8 shows schematically an apparatus and a method according to the invention;

FIG. 9 shows schematically an apparatus and a method according to the invention;

FIG. 10 shows schematically some steps of a method according to the invention;

FIG. 11 shows schematically some parts of an apparatus according to an embodiment of the invention;

FIG. 12 shows schematically other parts of the apparatus according to an embodiment of the invention;

FIG. 13 shows schematically other parts of the apparatus according to an embodiment of the invention;

FIG. 14 shows schematically an oscillating microjet printer in the process of coating a substrate;

FIG. 15 shows schematically the coating result obtained with the microjet printer of FIG. 14;

FIG. 16 shows schematically a top view of a part of the apparatus according to an embodiment of the invention; and

FIG. 17 shows schematically a method according to the invention, and an apparatus used therein.

For the sake of clarity, some embodiments of the invention are shown simplified in the figures. Similar parts are denoted with the same reference numerals.

### DETAILED DESCRIPTION OF SOME EMBODIMENTS OF THE INVENTION

The production system of hard coating and AR function coatings in the method according to the invention is based only on wet technique processes, in which the workpieces are preferably subject to continuous movement, irrespective of which work process is applied to them. Such a production method functions uninterruptedly in such a way that the product is inserted into the first end of the device implementing the method, and the finished product comes out of the second end of the device.

In an embodiment of the invention, the movement of the product is stopped at given intervals for the work processes, after which the product continues to move. The movement of the product and the conveyor system transporting it may be stepping, in other words the product is moved a step forwards, the movement stops for coating or the like work process, and the product is again moved a step forwards. Thus, the coating microjet head may be immovable relative to the product, or it may move in the direction of transport or in the direction transverse to this direction. The product is not, however, removed from the conveyor system for the work processes.

In the method according to the invention, a production system is integrated and automated which is based only on the wet technique process and in which a hard coating with varnish is combined with the production of an AR function with the sol-gel method. The varnish or sol-gel solution may be provided with additives which provide said layers with different functional properties, such as IR or UV blocking functions, a photochromic function or a colouring function, etc.

The method according to the invention is particularly well applicable—but not limited—to manufacturing optical three-dimensional (3-D) workpieces with a thickness of 1.2 to 12 mm, which thickness may vary, and with a diameter of 42 to 82 mm. Examples of such products are eyeglasses, sunglasses and protective eyepieces. Different applications of surface compositions may be produced with the method, the compositions having at least one coating layer or material comprising oxide material. The following compositions A to E can be mentioned as examples of such surface compositions:

A.

1. Adhesion coating and a first hard coating of nanofilled varnish, for example Al₂O₃, ZrO₂, SiO₂, ceramic or diamond nanofiller, with a thickness of 10 to 40 nm,

2. AR coating and a second hard coating with the sol-gel method, both of which coatings are created with the microjet method and then cured either thermally, with UV rays, IR rays or microwave rays.

B.

The same as A, but coated with the dip method.

C.

1. Adhesion coating and a first hard coating by dip varnishing with nanofilled varnish, the rest of the components being the same as in composition A,

2. AR coating and a second hard coating with the sol-gel method, the coating materials being spread with the microjet method.

D.

1. Adhesion coating and a first hard coating with the microjet method,

2. AR coating and a second hard coating with the sol-gel method, the coating materials being spread with the microjet method,

where the last hard surface is an oxide coating, such as Al₂O₃, ZrO₂ or ceramic coating, and manufactured with vacuum deposition, such as DC sputtering, PICVD (Plasma Impulse Chemical Vapour Deposition) or laser ablation method.

E.

Selective coating of a workpiece is an application in which the outer and inner side of the workpiece are coated with different materials in such a way that the function produced is different on different sides of the workpiece. In selective coating of a workpiece, the functions of the surface may be affected in different phases on at least three different levels: a) on the varnish layer, b) on the sol-gel layer, or C) on the vacuum-coated layer, if produced. If it is desirable to affect some functions on the varnish surface, these functions are typically the following:

Transition function positioned on the outer surface side of the workpiece, i.e. on the convex side, and IR and/or UV blocking on the inner surface of the workpiece, i.e. the concave side, implemented with ITO, ATO or other oxides having an optical window of 400 to 700 nm. It is known that varnishes have in general for instance TiO₂ particles for raising the refractive index.

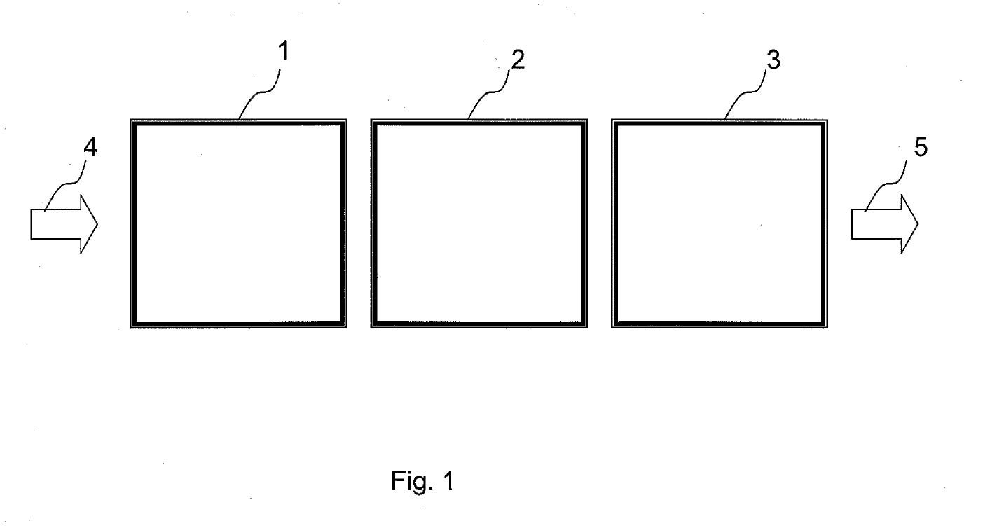

FIG. 1 shows schematically a phase diagram of the method according to the invention. In the method, three different work processes are integrated into a shared production line. The work processes are plasma etching and/or ultra-sonic cleaning 1, varnishing, preferably with a nanofilled hard varnish with a microjet method 2, and applying a sol-gel solution onto the hard varnish by using a microjet method 3 integrated into one single production line. The coating processes may be carried out in an inert gas atmosphere, such as argon, nitrogen, xenon, helium, dry air etc., which improves the quality, for instance hardness, of the coating. Further, it is preferable that the coating processes are performed in a clean room atmosphere.

The invention provides a solution to the following problems:

a) how to achieve excellent adhesion on the surface of the lens itself and between different coatings;

b) how to achieve a hard coating;

c) how to achieve an anti-reflective function (hereafter AR function), IR (Infra Red) and UV (Ultra Violet) blocking coating; and

d) how the different coatings can be positioned selectively on both sides of the workpiece in an automatic work process.

In the method, a coating may be produced selectively, in other words some areas may, if required, be left completely uncoated, for example one side of a lens, or given areas may be provided with thicker or thinner coating layers.

Coatings may be made for instance with microjet methods, which may include:

1. Inkjet printing as generally known;

2. Piezo-operated pressure jetting

3. Piezo-operated line jetting;

4. Oscillating microjet printing.

1. Inkjet Printer

Typically a system based on a piezo element and used for printing, in which each individual nozzle can be controlled independently and the size of each drop and the number of drops can be adjusted by a program. Allows accurate selective coating in a coating application, and accurate control of the variation in the surface thickness.

2. Piezo-operated pressure jetting, passive. Pressurized varnish is dispensed as drops with a fast-operating piezo valve. In the actual nozzle module, all nozzles simultaneously obtain the same pressure from the pump via the valve. The system is applicable to even surfaces in which the surface thickness produced is constant throughout the area. The pressure controlled with a piezo valve is very high, typically more than 10 Mpa (100 bar), even 200 Mpa (2 000 bar).

3. Piezo-operated line jetting, active. Prepressurized varnish is dispensed as drops at a rapid pace in the nozzle module by means of a heavy piezo element from several nozzles simultaneously, typically from more than five nozzle holes per one piezo element. The nozzles are divided between at least two nozzle modules, i.e. lines, each having at least two nozzles. The operation of a nozzle module can be controlled irrespective of the operation of the other nozzle modules. The system is applicable to even surfaces in which the surface thickness produced is constant throughout the area. The actual jetting pressure is produced in the jetting module with a piezo element, so the prepressurization needs not be high, typically below 10 Mpa (100 bar).

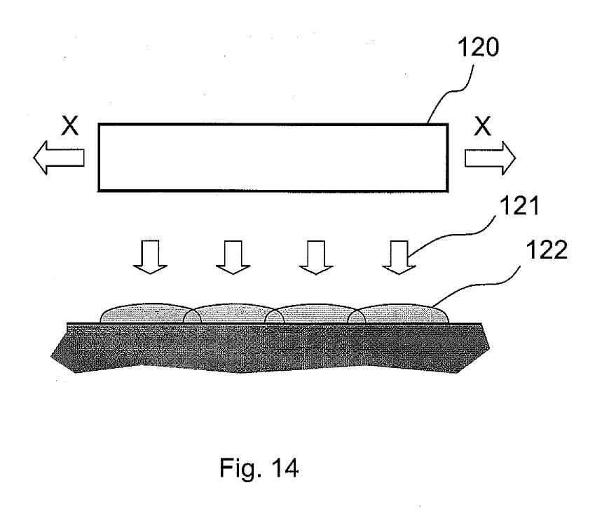

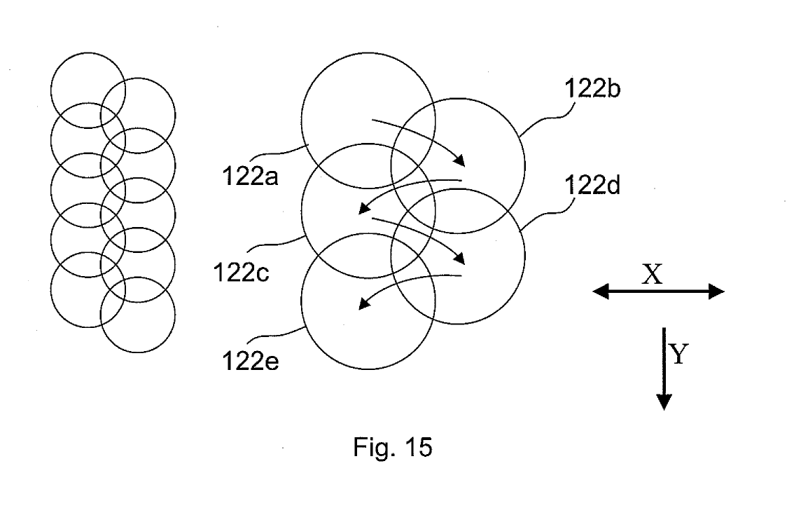

4. Oscillating microjet printing. This is described in more detail in connection with FIGS. 14 and 15.

The piezo nozzle typically operates by the force of an acoustic wave generated by the piezo element in the liquid jetted, in other words a drop flies out of the nozzle by the effect of the local pressure generated by the acoustic wave.

When using line jetting, the required pressure is typically generated by a separate pump, and when the valve opens, liquid jets out of the micro nozzle as long as the valve is controlled. Through the same valve, pressure can be fed into several nozzles that are typically mounted in lines in the coating solution.

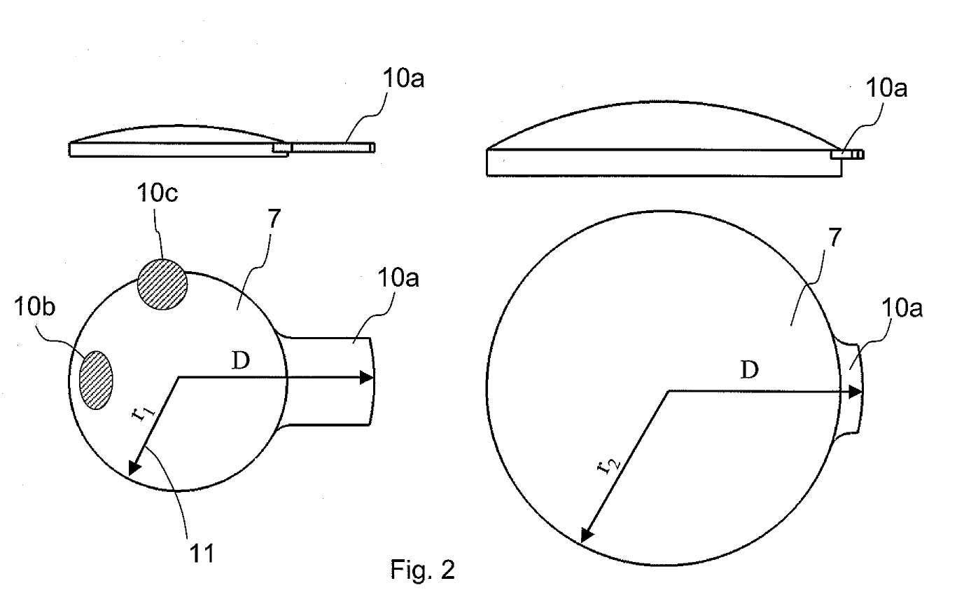

FIG. 2 shows schematically a side view and a top view of lens preforms used in the method according to the invention.

The workpiece, i.e. the lens or lens preform, comprises a jig 10a, 10b or 10c that may be integrated with an optical area 7, in other words the jig and the optical area 7 are seamlessly attached to each other and manufactured of the same material. A first embodiment of the jig 10a is a planar protrusion, the outermost edge of which is always at a standard distance D in relation to the centre point of the optical area 7, irrespective of the diameter r₁, r₂ of the optical area.

The left-hand lens or lens preform in FIG. 2 indicate two other alternatives to arrange the standardized jig 10b or 10c in the lens preform. The jig 10b, 10c may be an area which is arranged in the optical area 7 and which is always standard, irrespective of the size or shape of the optical area 7. Said area is arranged outside the useful area of the optical area. The useful area is that part of the lens or lens preform which is abraded away when the final lens is shaped to be suitable for a frame. If the lens or lens preform is coated with a microjet device, the device can be programmed to leave the area in question uncoated.

The jig may be provided with information by means of which the lens or lens preform can be identified.

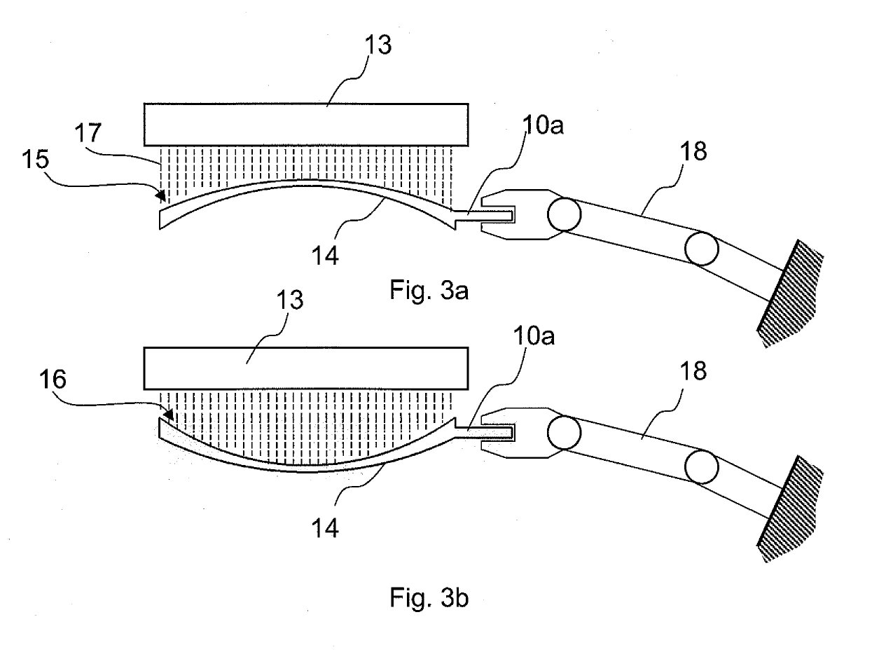

FIGS. 3a and 3b show schematically a side view of some steps of the method according to the invention. An optical workpiece 14 is coated with a printer 13 based on the microjet method. In the method, the first side 15 of the workpiece 14 is coated first, as shown in FIG. 3a. After this, the workpiece 14 is turned 180°, and its second side 16 is coated, as shown in FIG. 3b. The turning is preferably carried out with an automated mechanism, such as a gripper 18 attached to the protrusion forming the standard surface 10 of the workpiece 14. Any number of turns may be carried out for the workpiece 14.

The coating of the first side 15 may be the same as the coating of the second side 16. The parameters of the coating agent may be changed according to how much coating agent 17 is required for each particular side of the workpiece. Different points of the same surface may be coated with a different amount of coating agent, or with a completely different coating agent. Correspondingly, on the first side 15 coating layers may be used which are different from those on the second side 16.

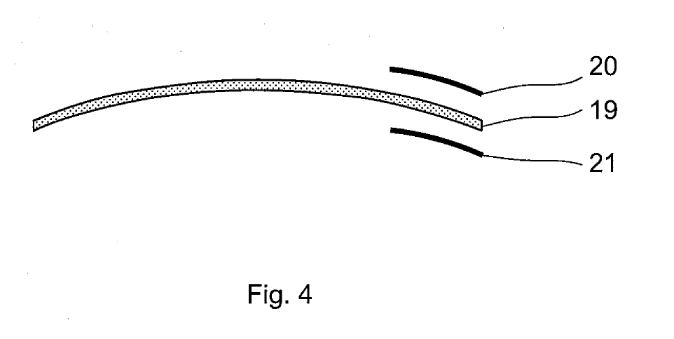

FIG. 4 shows schematically a side view of an optical product manufactured with the method according to the invention, indicating the different structural layers separately. The optical product comprises a workpiece 19 manufactured of a suitable plastic material. The workpiece 19 is coated selectively in such a way that a hard coating 20 containing a photochromatic function is arranged on its outside, whereas its inner side is provided with a hard coating 21 comprising an IR and/or UV blocking function implemented with ITO, ATO or another oxide known as such. The IR and/or UV blocking function may also be implemented by using suitable monomers. Many molecules absorb infrared zone light, the wavelength of which is between 800 and 1400 nm. This property is, as known, exploited in chemical analyses by using an IR spectrometer. These molecules may be added to the coatings without it impeding the polymerization process or the travel of visible light. In principle, such molecules are of two types: organic and inorganic. Inorganic molecules absorbing IR radiation include for example doped metal oxides, sulphides and selenides. Their working mechanism is based on displacement of electrons. When IR radiation comes to contact with a molecule like this, the wavelength that corresponds to the particular energy level difference is absorbed and released slowly. In this field, the most common material is ITO (Indium Tin Oxide). When such a material is mixed with organic material or composite material, an individual particle must be in the nano range, preferably about 20 nm at most.

Organic materials absorbing IR radiation are typically big molecules which are cis-trans-isomeric, in other words in which a double bond may twist around into two different positions. This isomerization mechanism may also be activated by the energy coming from photons of the IR zone. Just as in inorganic molecules, this energy is released slowly, and the molecule returns into the original position. In this category, the molecule most commonly used is phytochromobilin:

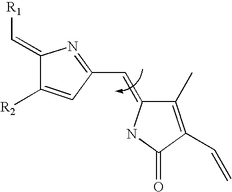

Phytochromobilin occurs in nature in some plants, in which it helps them adapt to the sunlight. Phytochromobilin belongs to the tetrapyrrole family.

The additives implementing the IR and/or UV blocking function may also be placed in the possible primer layer, i.e. adhesion layer, the primary purpose of which is to improve the adhesiveness between the coating and the substrate to be coated. Also colouring agents and pigments may be placed in the adhesion layer. The photochromatic function may be placed in the adhesion layer, hard coating varnish or sol-gel surfaces arranged on the outer side. There are organic and inorganic molecules that provide the photochromatic function. An inorganic molecule is the historical basis of photochromatic lenses. It is based on the capability of silver halides to absorb photons in the UV zone and to change into a relatively stable radical Ag* that absorbs almost the whole of the spectrum of visible light. This was commercialized by Corning with mineral lenses under the trade name ‘Photogray’. However, it has not been possible to implement this perpetual phenomenon in plastic lenses, because the molecules used are not compatible with the organic base material. Therefore, only nano-sized material would be possible in order to prevent the lens from cracking. Surprisingly, it has been possible to synthesize only silver-metal nanoparticles. Therefore, new means must be invented to manufacture AgCl, AgBr or AgI nanoparticles. As long as this cannot be done, there is no way to manufacture a photochromatic plastic lens functioning perpetually.

Organic molecules function in a different way. They are planar and large-sized. In UV light, they twist and obtain a three-dimensional shape. They may even turn from a ring form into an open form. As a result, the colourless molecules turn into coloured ones. This is shown in the following pictures:

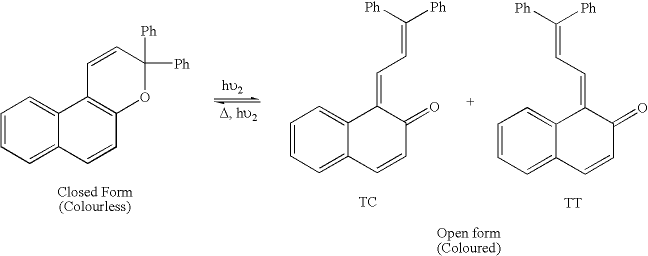

The name of this molecule is naphtopyrane. Unlike silver halides, this phenomenon is not perpetually reversible. The molecule cannot twist endlessly but tire over time. The active functioning of the molecule cannot be reversed. With these molecules, any colour may be obtained with photochromatic colouring agents.

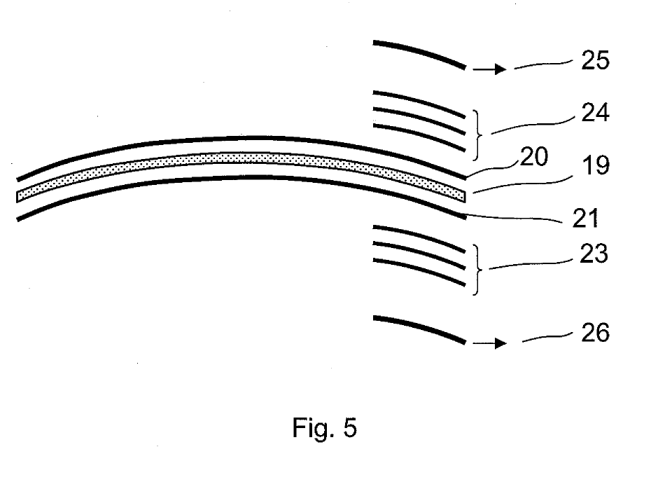

FIG. 5 shows schematically a side view of a second optical product manufactured with the method of the invention, indicating the different structural layers separately. The optical product is typically a spectacle lens having coatings that are, in most cases, relevant to its functions.

At first, the outer and inner surfaces of the plastic lens 19 are provided with a hard coating 20, 21, which is typically varnish, for example siloxane, acrylate or urethane, and preferably nanofilled, in which case the nanofiller, which has a size of 5 to 50 nm, is most preferably an oxide, such as SiO₂, ZrO₂, Al₂O₃ or ceramics or diamond. The thickness of such a varnish layer is typically 3 to 8 μm, and it is preferable, with respect to the new system, that this varnish be UV-, IR- or microwave-cured.

Next, AR surfaces 23 and 24 are positioned upon the varnish layers 20 and 21. There may be one or more layers of coating based on the sol-gel process. The thicknesses of the different sol-gel surfaces 23 and 24 vary between 20 nm and 200 nm, depending on the layer structure and the materials used.

Further, an antifog hard surface 25 and 26, which is also based on the sol-gel process, is positioned upon the previous layers.

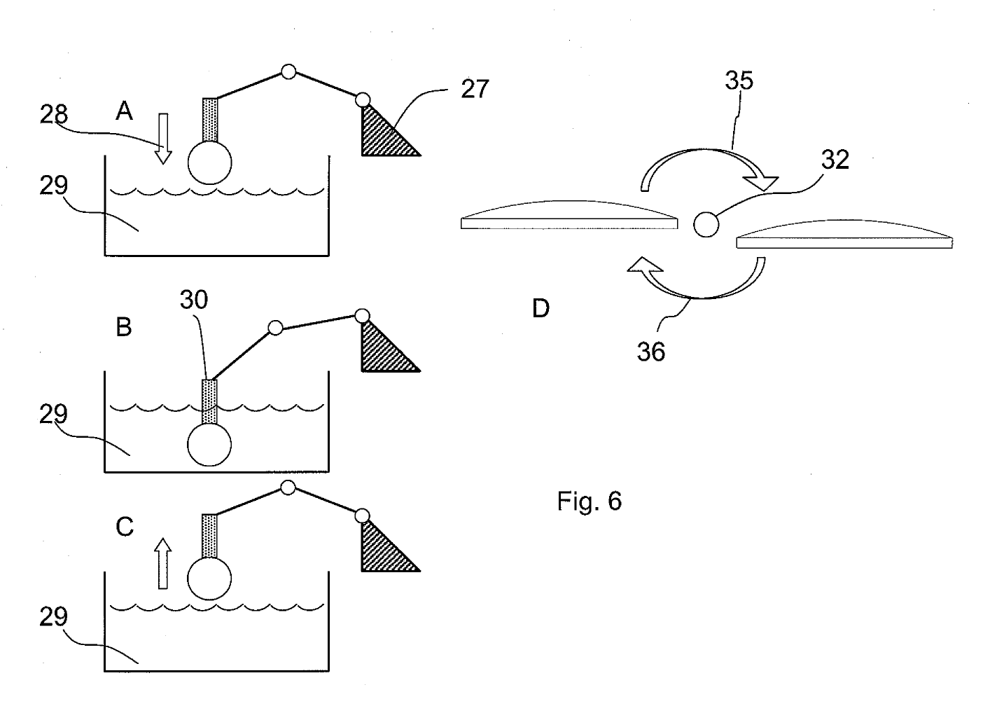

FIG. 6 shows a dip method. A robot 27 performs dip coating processes a, b, c and d. Also any manipulator may be used, but it is most preferable for the system that the product have a standard area 10 (in FIG. 2), which can be gripped in an automatic work process, such as in the dip coating process a to d in FIG. 6.

In step a) the gripper of the robot 27 has gripped a lens 28 and moves it in a controlled manner to liquid 29. In step b) the robot 27 keeps a workpiece 30 in the liquid 29 for a predetermined time, which may also mean more than one lifting. In step c) the robot 27 lifts the lens up from the liquid 29. Step d) shows that the workpiece or lens may be dried in a gas atmosphere, such as air, and turned into a horizontal position at least in directions 35 and 36 around its mid-axis 32 once or more times in such a way that the surface of the lens changes directions. In any case, this is significant to achieve even spreading of the varnish or sol-gel solution. Subsequently, the lens or preform is moved to the curing process of the coating, which is typically an IR, UV or MW (Micro Wave) process.

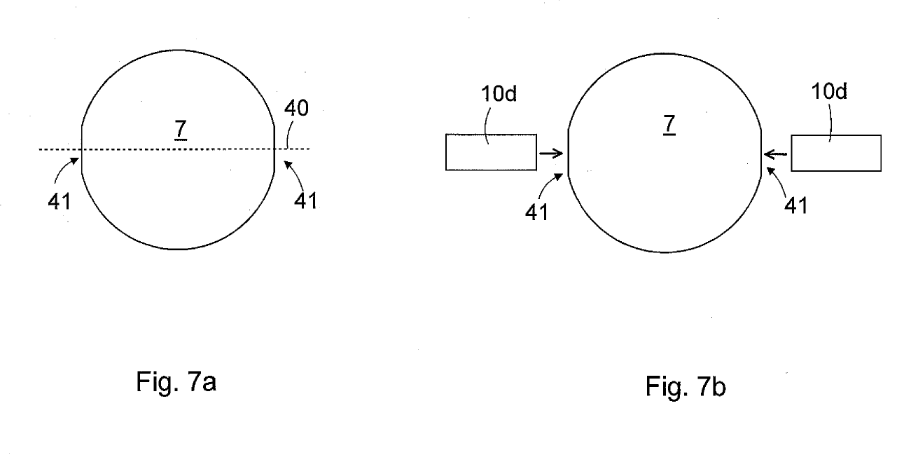

FIGS. 7a and 7b show schematically a top view of a lens preform used in the method according to the invention. The optical area 7 may be produced by injection moulding, for example. The jig, which is integrated into the optical area as already mentioned in connection with FIG. 2, may be injection-moulded at the same time. The material to be injection-moulded may be thermoplastic or thermoset. However, in some embodiments the jig cannot be arranged to the workpiece at the injection moulding phase. In that case it is possible for example to provide the border of the optical area 7 with at least one attachment surface 41, which in FIGS. 7a, 7b is substantially a plane. The jig 10d is then non-detachably attached to this attachment surface 41 e.g. by gluing, ultrasonic welding, laser welding, etc. The location of the attachment surface or surfaces 41 may be selected optimally in view of the further processing of the lens preform and the shape of the final lens. It should be noted at this point that the jig 10a-10d will be detached from the optical area 7 in a suitable process phase after coating.

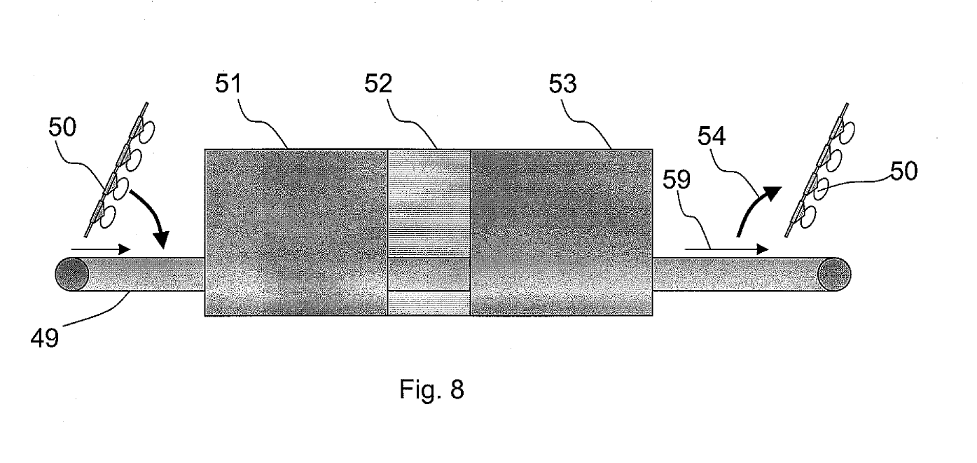

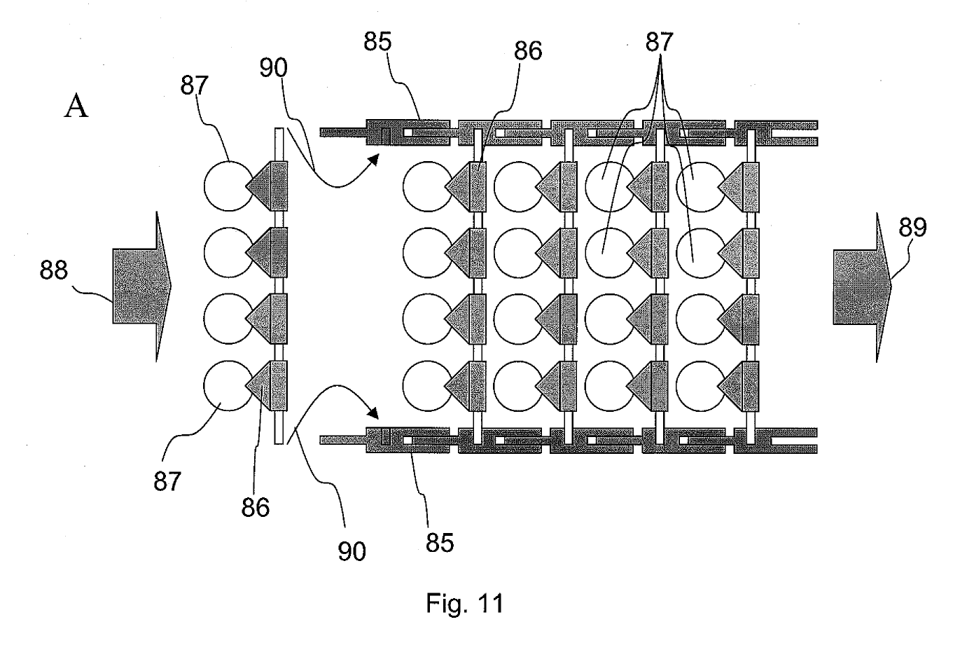

FIG. 8 shows schematically an apparatus and method according to the invention. The apparatus is provided with a conveyor system that may be similar to the one shown in FIG. 11, for example. The conveyor system is arranged to travel through an integrated coating system comprising at least the functions shown in FIG. 1.

The lenses and their jigs are positioned on a shaft 50 that is, most preferably, provided with more than one lens next to each other. The shaft is mounted on a conveyor 49, which takes it first to a varnishing unit 51 including a corona plasma etching device, a piezo varnising device and an IR/UV or microwave curing device.

The lenses continue directly through an intermediate space 52 to a sol-gel coating unit 53 including a corona plasma etching device, a piezo coating device and an IR/UV or microwave curing device. It is to be noted that the intermediate space 52 is not a necessary part of the system. It is often preferable to include it in the system, since it may be provided with means for removing gases etc. of the preceding step before the lenses move to the next step. The intermediate space 52 may also be provided with means for at least partly evaporating the solvent substances and/or partly curing the coatings. The intermediate space 52 may also be arranged between all successive steps. The length of the intermediate space 52 depends on the speed of the conveyor system and may be for example 0.5-5 m.

The conveyor 49 takes the products out of one end of the coating system, where the shaft 50 with its lenses is removed from the conveyor system.

All essential coatings are made in this integrated varnishing and sol-gel coating system, where the conveyor 49 transports the products to be coated through all coating processes at the same time, without interruptions.

Workpieces and lenses of different sizes and shapes are positioned on a determined jig in such a way that all the different work processes can be performed completely automatically, most preferably as a work process controlled digitally.

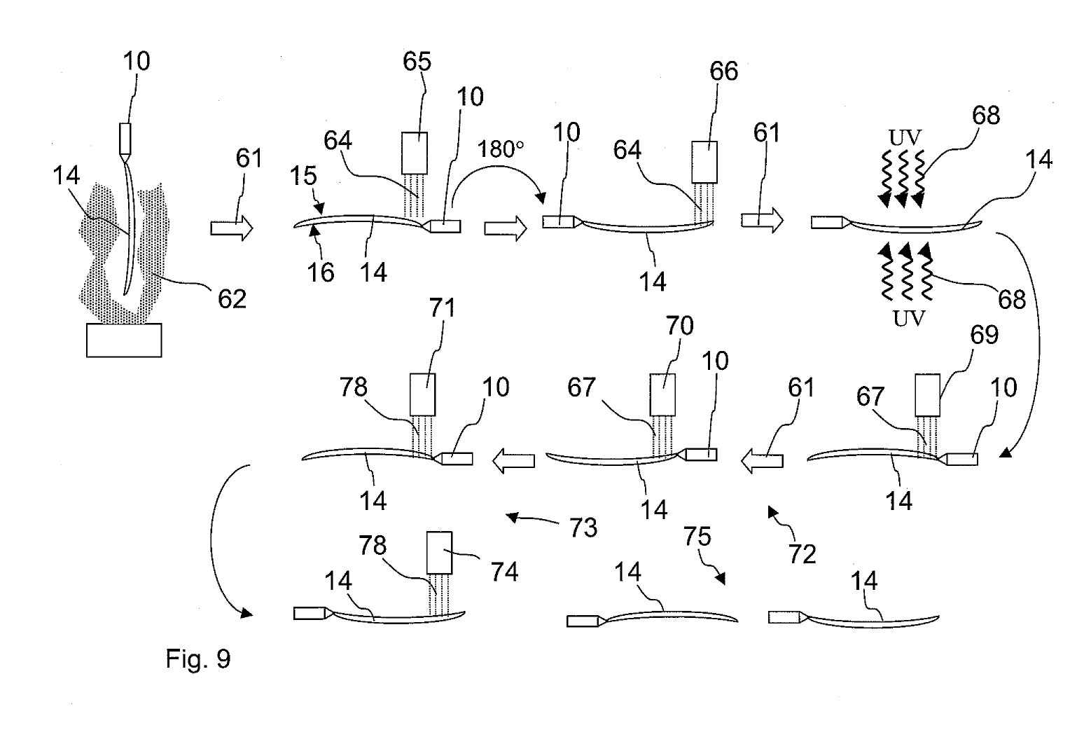

FIG. 9 shows schematically an apparatus and method according to the invention. The workpiece 14 treated in the method is a spectacle lens, but it is obvious that the method shown is also applicable to treating optical workpieces. The workpiece 14 is coated with three coatings.

The first method step is ultrasonic cleaning of the workpiece, not shown in the figure. During the ultrasonic cleaning, the workpiece 14 is preferably in a substantially vertical position. After the ultrasonic cleaning, the workpiece 14 is taken to a corona plasma treatment 62, in which both sides of the workpiece 14 are treated. In another embodiment of the method, only one side, i.e. one surface, of the workpiece 14 is treated. Before the plasma etching the workpiece 14 is preferably treated with dry ice blown onto the surfaces thereof. The workpiece 14 is attached to a jig 10 that is, in turn, preferably arranged on a turning mechanism operating automatically.

In the next method step the workpiece 14 is coated with an adhesion coating, material 64 forming the adhesion coating being jetted with microjet printers 65 and 66. The material 64 is, for example, urethane-based coating agent. During the coating, the workpiece 14 is in a substantially horizontal position. First, the first side 15 of the workpiece is coated with the microjet printer 65, after which the workpiece 14 is turned around and the second side 16 of the workpiece 14 is coated with the second microjet printer 66. The thickness of the adhesion coating is, for example, about 1 to 3 μm. The workpiece 14 moves all the time and with an uninterrupted movement in the direction of arrow 61, both during the coatings and between them.

In the next method step, the adhesion coating is subjected to intermediate curing with UV radiation 68 or, for instance, microwave radiation. In the intermediate curing, the adhesive coating is not cured to its final hardness but to a curing degree of, for example, 50%.

Next, the workpiece 14 moves to a second coating step indicated by reference numeral 72. In this step, the workpiece 14 is coated, in other words a coating is applied onto the adhesion coating, by using a second coating material 67. First, the first side 15 is coated, after which the workpiece 14 is turned around and the second side 16 is coated. The coating is made with a third and fourth microjet printer 69 and 70. The second coating is most often a hard coating. Its thickness may be, for example, 5 to 10 μm. The purpose of the hard coating is to provide the surface of an organic lens with a scratch-free layer and to create compatibility for an AR coating by “imitating” a mineral glass surface. Often, but not necessarily always, the hard coating comprises five components:

1. Adhesion-improving hard silane monomer (e.g. GLYMO)

2. Hard silane monomer (e.g. TEOS: Si(OC₂HO₄)

3. Sol-Gel nanoparticles (e.g. Al₂O₃)

4. Solvent (e.g. Methoxy-propanol)

5. Agent improving the evenness of the surface (e.g. Byk 340).

There is an optimal point where the best adhesion and hardness are achieved at the same time. This is particularly critical if the material to be coated is for instance polycarbonate (PC). When the aim is maximum hardness and adhesion, in most cases the optimal point can be achieved only by means of a primer layer or an adhesion layer. Primers are agents with which the surface of an organic material can be provided with an adhesion-improving layer. They may also be called varnishes with maximum adhesion but without maximum hardness. Primarily, they belong to the polyurethane group. Various functional substances may be mixed into the primer.

In the third coating step 73, the workpiece 14 is coated on both sides with material 78 forming an antireflection coating. The hard coating made in the preceding coating step may be partly cured before the material 78 is dispensed onto the workpiece 14. The antireflection coating preferably also includes an antifog function. The workpiece 14 is again turned 180° when the first side 15 of the workpiece has been coated. The material 78 is dispensed with fifth and sixth microjet printer 71 and 74.

Next, the workpiece 14 comprising thus the coatings made in the previous steps is taken to a sol-gel coating process 75. Here, an outer coating is made for the workpiece 14 with the sol-gel method. The sol-gel solution may be dispensed with microjet printers not shown in the figures. The sol-gel coating method involves manufacturing an inorganic, partly inorganic and partly organic, or organic coating. One organic coating that can be mentioned in this context is a coating made of a fluorated polymer. The thickness of a sol-gel coating may be about 120 nm, for example.

When all coatings have been arranged on the workpiece 14, the curing of the coatings is performed to their final hardness. During the curing, the workpiece 14 may be turned from one position to another.

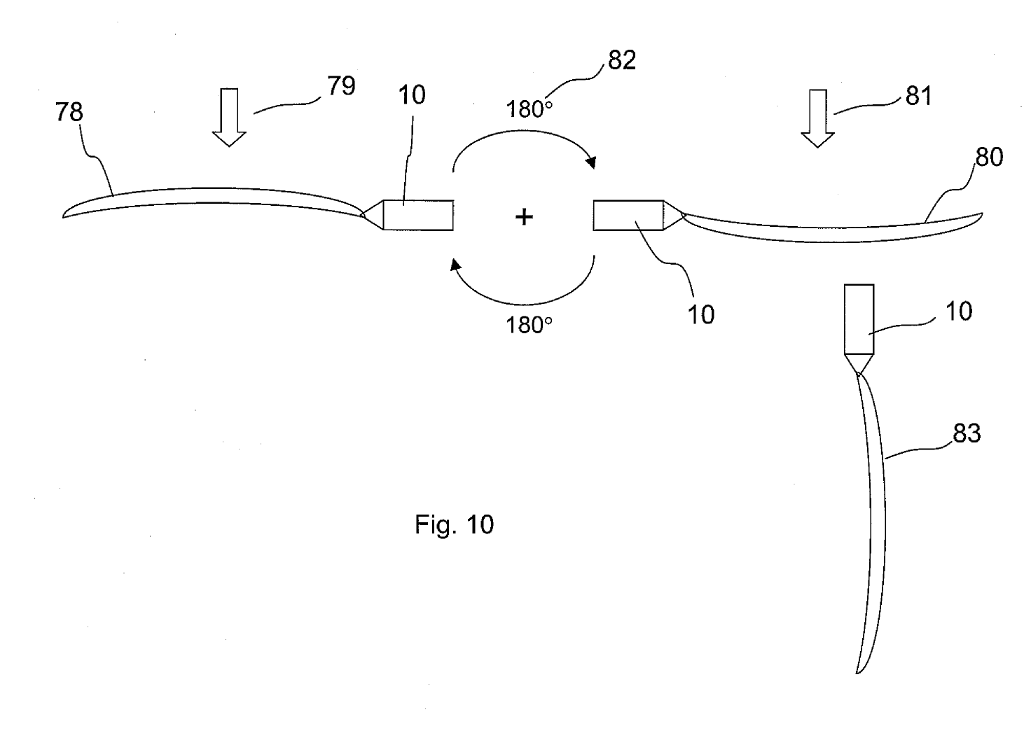

FIG. 10 shows schematically some steps of a method according to the invention.

The different work processes are performed for both sides of the lens, i.e. convex side 78 and concave side 80. The coating is carried out in such a way that the lens is in a substantially horizontal position because otherwise it would be very difficult to achieve a homogeneous, accurate surface thickness. In this way, uncontrollable runoff of the coating is also prevented when the coating is still wet. In plasma corona etching, in turn, the lens is preferably in a vertical position.

The lens may be turned and kept in any position in all the different work processes. FIG. 10 shows specifically this function where the lens is in different positions 78, 80 and 83 in such a way that the desired work process can be performed in optimal conditions.

The coating of the varnish or sol-gel solution itself is most preferably carried out by spraying from above 79 and 81 onto the lens 78, 80 in the horizontal position.

The lens 78, 80 and 83 may be turned 180°, 90° or to any angle because the lens is positioned in a jig that is, in turn, compatible with the conveyor taking it through all the different work processes. Thus, the size and external form of the lens are of no importance.

FIG. 11 shows schematically some parts of an apparatus according to the invention. More than one lens 87 may preferably be positioned next to each other on one single shaft. Subsequently, the shaft to which fasteners 86 have been attached may be placed 90 in a conveyor system 85 moving at a predetermined speed, for example from left 88 to right 89. The conveyor system 85 takes the lenses 87 through all the different work processes, preferably in such a way that the lenses 87 are turnable to any position.

The fasteners 86 may contain an identification code, as may the shaft itself, on which several lenses 87 and the fastener 86 have been placed, so each individual product is identifiable anywhere during the work processes or after them.

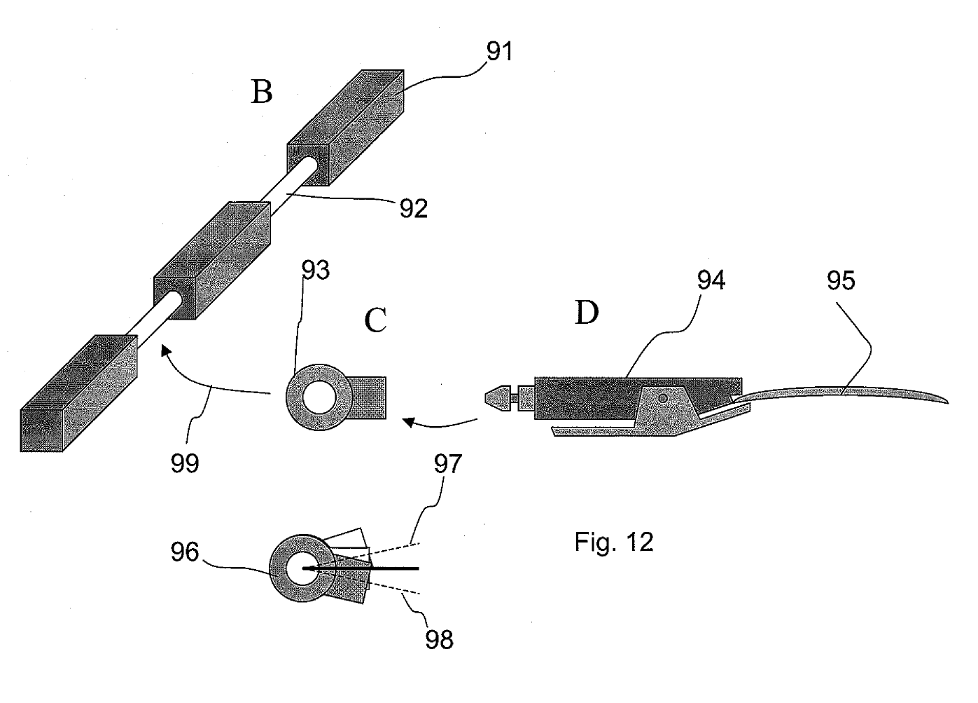

FIG. 12 shows schematically other parts of the apparatus according to an embodiment of the invention. The shape and functioning of the jigs may naturally vary. The jig shown in FIG. 12, for example, functions in such a way that a lens 95 is pressed between two planes in a fastener 94 that can be attached to a counterpart 93, for which there is a place 92 in a conveyor bar 91, for instance. The lens may be moved, for example ±40°, because the counterpart 96 of the fastener 94 is articulated.

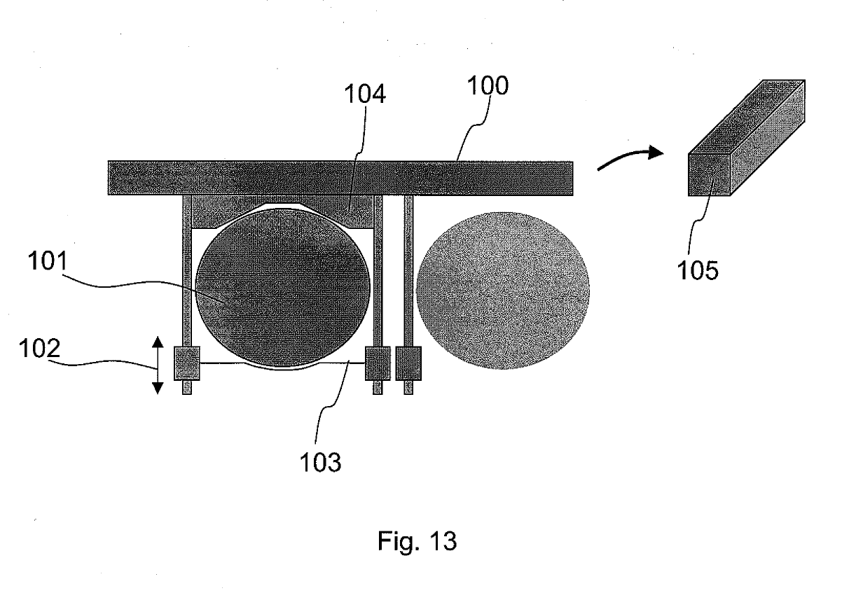

In a second fastener application, which is shown in FIG. 13, a lens 101 is pressed between two planes 103 and 104 by the ends of the lens. The pressing planes 103 and 104 are preferably a part of a conveyor bar 105. The distance between the pressing planes 103 and 104 may be changed in the manner shown by arrow 102. The pressing planes or surfaces may be arranged to be flexible by making them of flexible plastic, for example. In one fastener application, the jigs are formed of sideward-directed protrusions, which are made of flexible plastic and shaped in pairs in such a way that a space for the lens 101 is formed between two protrusions. The counter surface of the protrusions, against which the lens 101 is arranged, is shaped curved and possibly has a groove, and these shapes combined with the force pressing the lens 101 of the protrusions keep the lens 101 firmly in place during the coating processes. Such jigs may be manufactured for instance by injection moulding—preferably together with the conveyor bar 105. An advantage of an all-plastic jig system is that it does not cause difficulties when microwave curing is used for curing coatings.

One problem is that if it is desirable to arrange several functional coatings on said products, it is very expensive with present-day methods. The known present-day methods are based on producing a hard coating with dip varnishing, using for instance acrylate siloxane or urethane varnishes. The antireflective function, i.e. AR function, in turn, has been provided by vacuum deposition of oxide layers with different refractive indices on top of each other. Typically, such oxide layers are for example SiO₂, TiO₂, ZrO₂.

In the known methods chemical welding is carried out first, dip varnishing being performed after that and the workpiece being air-dried and cured. The vacuum deposition, in turn, is carried out in a completely separate device, which is batch-operated.

One problem is that in dip varnishing the variations in the surface thickness are considerable, typically even 100% or more. Further, it is not possible or it is very difficult to produce layers of over 6 μm in dip varnishing. Correspondingly, it is difficult, if not impossible, to produce varnish layers of under 0.8 μm with dip varnishing.

It is, for example, impossible to arrange a photochromatic function in the varnish because it requires a thickness tolerance of under ±5%. Correspondingly, colouring the lens by means of varnish is excluded because it, too, requires a surface of a very even thickness. The thickness differences of the varnish resulting from dip varnishing also cause the problem of the varnish being over-cured at thin points and correspondingly under-cured in thick varnish layers.

FIG. 14 shows schematically an oscillating microjet printer in the process of coating a substrate. A nozzle unit 120 oscillates in direction X, in other words in the transverse direction relative to the direction of travel of the substrate, preferably at least ±0.01 to 2.0 mm, i.e. at least the distance between two nozzles. Thus, varnish drops 122 do not become positioned only in direction X, horizontally on top of each other (partly or completely), but also in direction Y, i.e. vertically on top of each other. This is shown in more detail in FIG. 15. The oscillating frequency can be, for instance 1 to 100 000 Hz, preferably 10 to 10 000 Hz, more preferably 100 to 1000 Hz.

FIG. 15 shows schematically a top view of the coating result obtained with the microjet printer of FIG. 14. Oscillation in direction X combined with movement Y, which is the course of movement of the product, e.g. 2 m/min, affects the morphological evenness of the coating surface produced as well as the evenness of the surface in general.

After the first drop 122a (sol-gel, varnish or any other substance) the next drop 122b becomes positioned, due to oscillation and movement, slightly more on the side and partly covers the preceding drop 122a. When the next drop 122c is placed therein, it partly covers both the drop 122b and the drop 122c etc. During the displacement in direction X, one or more drops can be dispensed on the substrate. In the embodiment of FIG. 15, one drop is dispensed in each direction.

In one embodiment of the invention, oscillation of the nozzle unit 120 may be stopped for a desired time, after which the oscillation can be continued. If required, the whole substrate may be coated with a non-oscillating nozzle unit 120. Oscillation, i.e. its wideness and/or frequency, can preferably be adjusted and controlled by digital control means known as such. Thus it is possible, at the same time, both to manufacture very even surface of optically good quality and to accurately limit the area to be coated.

A microjet printer enables manufacturing of coatings such as hard coatings, IR-blocking and UV-blocking coatings, AR coatings, antifog coatings and other functional coatings in which the thickness variation required of the coating is small and in which the morphological surface evenness must be good.

With sol-gel coatings spread with a microjet printer, very effective AR surfaces can be produced because thickness tolerance of ±1.25% in the thickness of the surface can be achieved.

Also, the microjet printer according to the invention enables spreading of thicker coatings, e.g. varnish coatings of 3 to 30 μm, even if they contain nanofillers, as the optical varnish products always do. This, too, is impossible to achieve with known inkjet printer solutions because nanofillers, such as TiO₂, ZrO₂, Al₂O₃, TaO₅, SiO₂, usually oxides or ceramic nanofillers, pack specifically at that location where the printer nozzles position them. Adding diluent does not help because the viscosity of the coating agent would decrease so much that there would be runoffs that would not be controllable. A runoff in a coating area means that the surface thickness is not constant, whereby it is of no use at least in the manufacture of optical or functional coatings.

The optimal viscosity of a coating agent is 9 to 20 cPs when the temperature of the coating agent is 20° C. to 30° C. The viscosity of the coating agent itself may be higher, for example 30 cPs at a temperature of 20° C., but the printer head may be provided with a heating element, with which the viscosity can be decreased to the optimal level of 9 to 15 cPs when the agent reaches the printer nozzle. Thus, the solvent content of the coating agent may be considerably lower but the viscosity level required by the nozzle is still achieved.

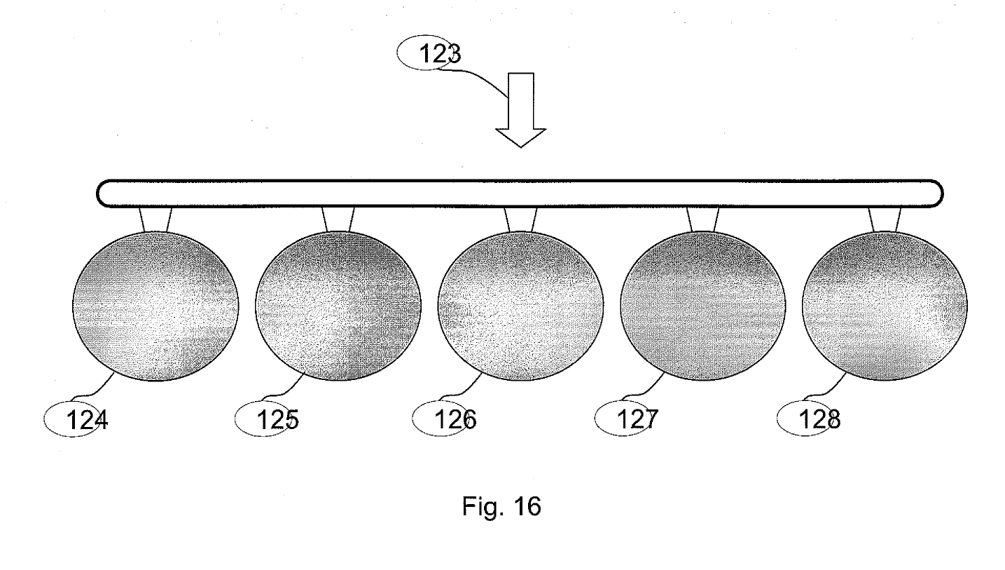

FIG. 16 shows schematically a top view of a part of the apparatus according to an embodiment of the invention. Five optical workpieces 124, 125, 126, 127, 128 have been injection-moulded of viscous material, such as plastic. Plastic may be for example polyamide, for example PAl2, polycarbonate, polymethyl-methacrylate, polyolefin or the like. The workpieces 124 to 128 have been injection-moulded simultaneously in a multi-impression mould. This mould also comprises a distributing channel, in which also the sprue 123 of the distributing channel has been formed. This is, in a manner known as such, fixed to the workpiece 124 to 128. In this case, the distributing channel has been shaped in such a way that the sprue 123 formed by it can be used as a load-bearing beam or bar, which forms a part of the conveyor system of the apparatus. With this the workpieces can be attached to the conveyor system, and the separate shafts and conveyor bars shown in FIGS. 11, 12 and 13 can be replaced. It is to be noted that the number of workpieces 124 to 128 integrated into the sprue 123 may naturally be other than five. The workpieces are detached from the sprue 123 when the required coating steps have been carried out.

On a general level, it can be noted that one aim is to provide as hard a surface as possible for a viscous material, such as plastic, but in such a way that the good properties of plastic are retained, for example impact resistance, easy and simple formability and incorporation of additional functions. Simplified, it can be said that it is desirable to achieve, at the same time, the hardness of glass and the impact resistance of plastic.

Plastic in itself cannot independently be as hard as glass, e.g. Bk7 or quartz glass. It is known that specifically for changing the surface hardness of plastic, plastic is hard-coated with, for instance, acrylate-, siloxane- or epoxy-based coatings, which are generally called varnishes. The coating methods include for example a dip, air spray or spin-coat varnishing method, or digitally controlled microjet methods not known from the prior art.

If the aim is to manufacture a very hard surface, for instance quartz-like one, but still to retain the excellent properties of plastic, also the hardness properties of plastic itself must be affected. Irrespective of the hardness of the coating placed upon the workpiece, the coating cannot be so thick that its properties alone would give surface hardness corresponding to glass when the surface is subjected to stress. The reason is that the thermal expansion coefficients of the plastic and the coating, respectively, are so different that too thick a coating is simply peeled off. If the hard coating, e.g. siloxane varnish, is positioned directly upon the plastic, the typical maximum thickness is about 6 μm. If, on the other hand, a primer intermediate coating, such as urethane, polyurethane, epoxy, siloxane or the like primer coating, is used, the thickness of the hard coating may be raised to more than 10 μm, e.g. to 20 μm. A typical surface produced with dip varnishing has a thickness of about 4 μm at maximum. However, even if the coating were very hard in itself and its thickness for instance 25 μm, which can be considered an extremely thick coating, it would not make the surface glass-like with regard to the hardness of the surface when it is subjected to stress. The reason is that the basic material, i.e. plastic, is soft. Therefore, subjected to stress, the coating gives way. Only by affecting the hardness properties of plastic as well can a comprehensive solution be achieved which combines the desired good properties of glass and plastic.

The polymer structure of the plastic itself can naturally be affected but it does not give the required additional value. The hardness is primarily affected by determined fillers mixed into the plastic raw material. It is known as such to mix inorganic fillers into an organic viscous material, such as plastics and varnishes. For example, glass fibre and glass filler have always been mixed into plastic. Correspondingly, varnishes have been provided with quartz particles, i.e. glass-nanoparticles, to achieve greater hardness, or titanium oxide particles to change the refractive index. The problem here is that when nanoparticles of a size of 10 to 30 nm, for example, are mixed into either plastic or varnish, they tend to cluster, in other words they deposit together into indefinable groups. With regard to a varnish, the problem may be solved in such a way that the nanoparticles, for example SiO₂ particles of 20 nm, are coated with a silane coating, for example. In this way, coated nanoparticles can be mixed directly into the varnish. As regards plastic, the problem may be that the nanoparticles are not distrubuted evenly to a plastic material in dry form, for instance in granulate or powder form.

For the above reason, nanoparticles, whether they are coated or not—most preferably coated, though—are most preferably mixed into plastic raw material at what is called the wet phase. As regards polycarbonate (PC) and epoxy, for example, this would mean that a nanoparticle is mixed in the production phase of plastic into one of its components, such as BISFENOL-A in epoxy. In this way, it is possible to produce a plastic type doped completely homogeneously and comprising nanoparticles. A workpiece manufactured of such a plastic type may be coated with a coating having nanoparticle mass distributed completely homogeneously. Owing to the homogeneity, the layer thickness of the coating is accurate and may be over 5 μm, most preferably over 10 μm. By means of the microjet method, an optimal surface thickness is achieved in which the thickness tolerance is, with regard to the whole surface, under ±5%, most preferably under ±1%.

In addition to oxides, the filling agent may be CNTs (Carbon Nano Tubes) or fullerenes, e.g. C₆₀, that are, in their most preferable form, coated to prevent clustering. Preferably, the plastic itself to be coated and the coating agent contain the same nanofiller material. Thus, covalent bonds are provided between the piece and the coating during the process. One application according to the method is that nanofillers are added to plastic, nanofillers are mixed into varnish and the thickness of the coating made of this is over 5 μm, most preferably over 10 μm, the thickness tolerance being under ±5%, most preferably under ±1%, and further that the spreading manner of the varnish or sol-gel coating is a microjet method.

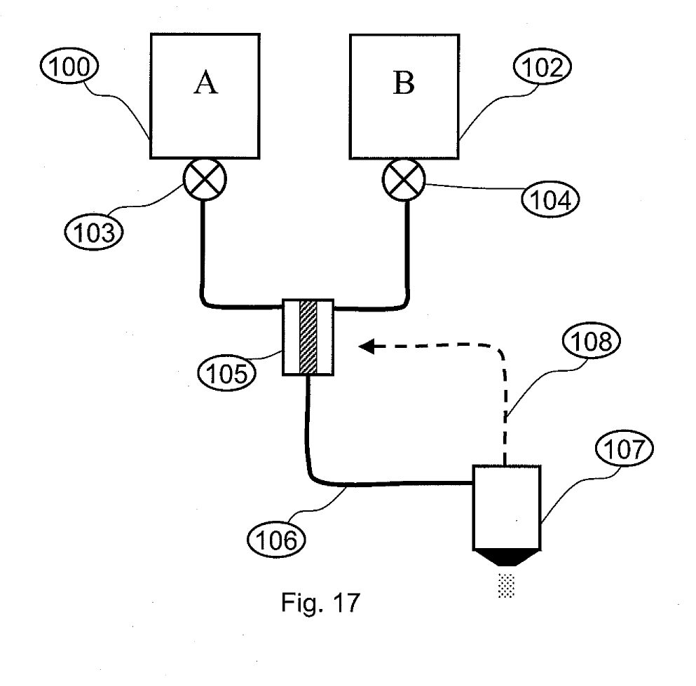

FIG. 17 shows schematically a method according to the invention and an apparatus used therein. The coating agent is formed of two components A and B. The coating agent may be, for example, varnish or sol-gel material. The different components of the coating agent are here kept separate as long as possible before coating. The coating agent may be, for example, a two-component urethane-based or epoxy-based varnish. Nanoparticles may be mixed into the coating agent, either into component A or B, or into both of them. Components A and B are separately in their respective containers 100 and 102, combined only in a mixing space 105. The coating agent is supplied from the mixing space 105 along a shared channel 106 to the jet head 107 of the microjet device. The working life of some coating agents is very short, for example only a few minutes. For this reason, the distance from the mixing space 105 to the jet head 107 itself is preferably as short as possible.

The mixing proportion of components A and B of the coating agent may be controlled by a program and changed for example in the middle of the run by adjusting the pumping rates of pumps 103 and 104.

Particularly thin sol-gel surfaces that typically have a thickness of 100 to 300 nm require that the nanoparticles be mixed into the matrix in the correct manner. Thus, the nanoparticles are typically treated in such a way that their agglomeration, i.e. clustering, is minimized or even completely prevented. The nanoparticles, as also the agents preventing their agglomeration, may be first mixed into a diluent, for example.

The containers 100 and 102 of the different components A and B may be provided with heat regulation means, and each may be adjusted to its respective optimal temperature. The containers 100 and 102 may be cooled. The components may be kept cold, for instance at a temperature of −25° C., as far as to the jet head 107, which, in turn, may be heated.

In some cases, features described in this application may be used as such, irrespective of other features. On the other hand, features described in this application may, if required, be combined to form different combinations.

The drawings and the related specification are only intended to illustrate the idea of the invention. The details of the invention may vary within the scope of the claims.

1.-9. (canceled)

10. A method of manufacturing an optical workpiece, comprising:
coating at least one side of the workpiece, and handling the workpiece through a jig attached non-detachably to an optical area of the workpiece.

11. A method according to claim 1, comprising handling the workpiece through a jig that is seamlessly attached to the workpiece and manufactured of the same material with the workpiece.

12. A method according to claim 1, comprising spreading a coating-forming agent by using a microjet printer.

13. A method according to claim 3, wherein the microjet printer is an oscillating microjet printer.

14. A method according to claim 1, comprising performing coating processes in an inert gas atmosphere.

15. A method according to claim 1, comprising a first coating being a varnish coating, and an outer coating being a sol-gel coating.

16. A method according to claim 1, comprising blowing dry ice onto the surface of the workpiece before the plasma etching phase.

17. An apparatus for manufacturing an optical workpiece out of a workpiece, the apparatus comprising means for treating the workpiece through a jig attached non-detachably to an optical area of the workpiece.

18. An apparatus according to claim 8, wherein the workpieces are manufactured with an injection moulding method and that a sprue formed in the injection moulding is arranged to function as said jig.
